(19) United States
(12) Patent Application Publication
(10) Pub. No.: US 2005/0028323 A1
(43) Pub. Date: Feb. 10, 2005

(54) Support for a vehicle grab handle and grab handle

(75) Inventors: Francis Meyer, Haguenau (FR); Joerg Wagner, Kaiserslautern (DE); Reinhard Krause, Marktredwitz-Brand (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive Electronics & Components GmbH & Clo. KG

(21) Appl. No.: 10/891,593

(22) Filed: Jul. 15, 2004

(30) Foreign Application Priority Data
Jul. 16, 2003 (DE) 203 10 944.9

(51) Int. Cl. A23P 1/00

(52) U.S. Cl. 16/445

(57) ABSTRACT

A support for a vehicle grab handle comprises a mounting part provided to be fastened to the vehicle, a support part provided to be joined to a grip part, and a support spindle by which the support part is rotatably supported on the mounting part. The support spindle is formed as an integral part of the mounting part and is injection-molded into the support part so as to be rotatable.

The invention relates to a support for a vehicle grab handle, comprising a mounting part provided to be fastened to the vehicle, a support part provided to be joined to a grip part, and a support spindle, by which the support part is rotatably supported on the mounting part.

### BACKGROUND OF THE INVENTION

Heretofore, the mounting part and the support part have been manufactured as separate components and then assembled, by inserting the support spindle into the mounting part. The large total number of individual components results in significant assembly expense and high costs. In addition, faulty assemblies are possible. Finally, the opening for the support spindle in the mounting part is visible from the exterior, which impairs the optical impression.

The object of the invention is to improve a support of the type mentioned above such that a simplified manufacturing process and therefore lower costs are the result.

### BRIEF DESCRIPTIONS OF THE INVENTION

To achieve this object, provision is made according to the invention that the support spindle is integrally designed with the mounting part and is injected into the support part so as to be rotatable. The two components are therefore manufactured in finished, assembled form, for example, in that first the support part is injection-molded so as to have a support opening for the support spindle, and in a second step, the mounting part is injection-molded, the support spindle being injected directly into the support opening of the support part. It is therefore no longer necessary to handle and to assemble the support spindle as a separate component. Therefore, the danger of faulty assembly is also eliminated. In addition, no externally visible opening for the support spindle is necessary in the mounting part.

For manufacturing the support spindle using injection molding in the interior of the mounting part, a method can be used such as is known from DE 33 40 122 A1, which is incorporated herein by reference with regard to the manufacturing method. Briefly summarized, in this method, a first injection-molded part is manufactured in a first mold. Then the first injection-molded part is removed from the first mold and is transferred to a second mold. In the process, the first injection-molded part hardens and acquires rigidity to the point that an injection-molding material can be injected into the second mold, the material, for example, filling an opening in the first injection-molded part and hardening therein to form a second injection-molded part. The second injection-molded part is then movable within the first injection-molded part, but it can still be undetachably joined thereto. In any case, the result has the essential advantage that the second injection-molded part does not have to be assembled on the first one.

The invention further relates to a grab handle comprising two supports and a grip part that is joined to the two support parts.

Advantageous configurations of the invention can be seen in the subclaims.

### BRIEF DESCRIPTION OF THE DRAWINGS

The invention is described below on the basis of several embodiments which are depicted in the attached drawings. In the drawings,

FIG. 1 in a perspective view depicts a grab handle composed of a grip part and two supports;

FIG. 2 depicts the grab handle from FIG. 1 in an exploded view;

FIG. 3 in a side view depicts one of the supports of the grab handle from FIG. 1;

FIG. 4 depicts a sectional view along the plane IV-IV from FIG. 3;

FIG. 5 in a side view depicts the other support of the grab handle from FIG. 1;

FIG. 6 depicts a sectional view along the plane VI-VI from FIG. 5;

FIG. 7 depicts the support part of the support depicted in FIG. 3, before a return spring is attached;

FIG. 8 depicts the support part from FIG. 7, with the return spring attached;

FIGS. 9 and 10 in perspective view depict the return spring from FIG. 7;

FIGS. 11 and 12 in perspective view depict a return spring according to one variant;

FIG. 13 in a perspective view depicts the support from FIG. 5, before a damper is attached;

FIG. 14 depicts the support from FIG. 13 in a further perspective view;

FIG. 15 depicts the support from FIG. 13 just before a damper is attached;

FIG. 16 in a perspective view depicts a mounting part according to an alternative embodiment; and

FIG. 17 in a perspective view depicts a support having a mounting part in accordance with yet another embodiment.

### DETAILED DESCRIPTION OF THE INVENTION

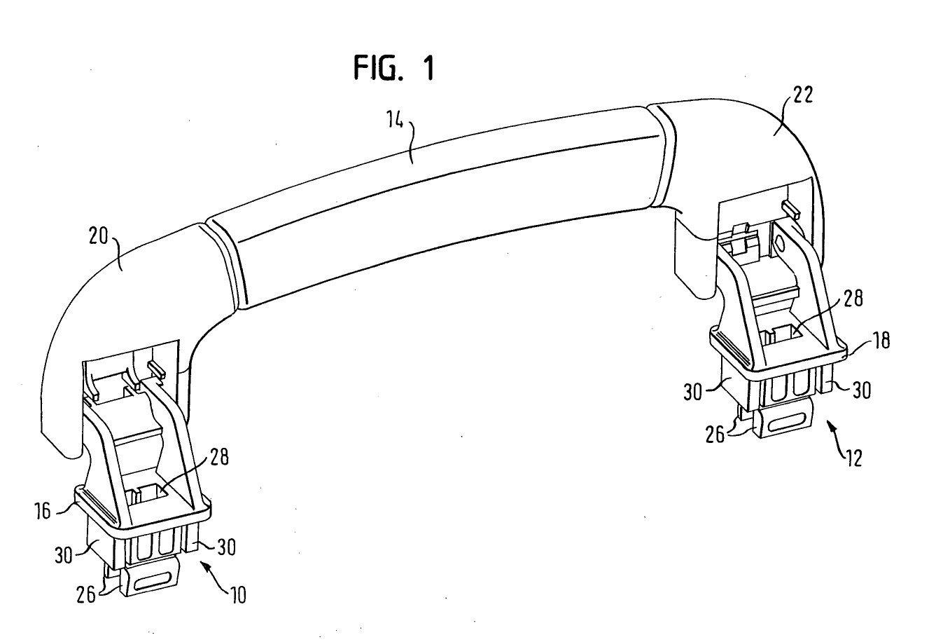

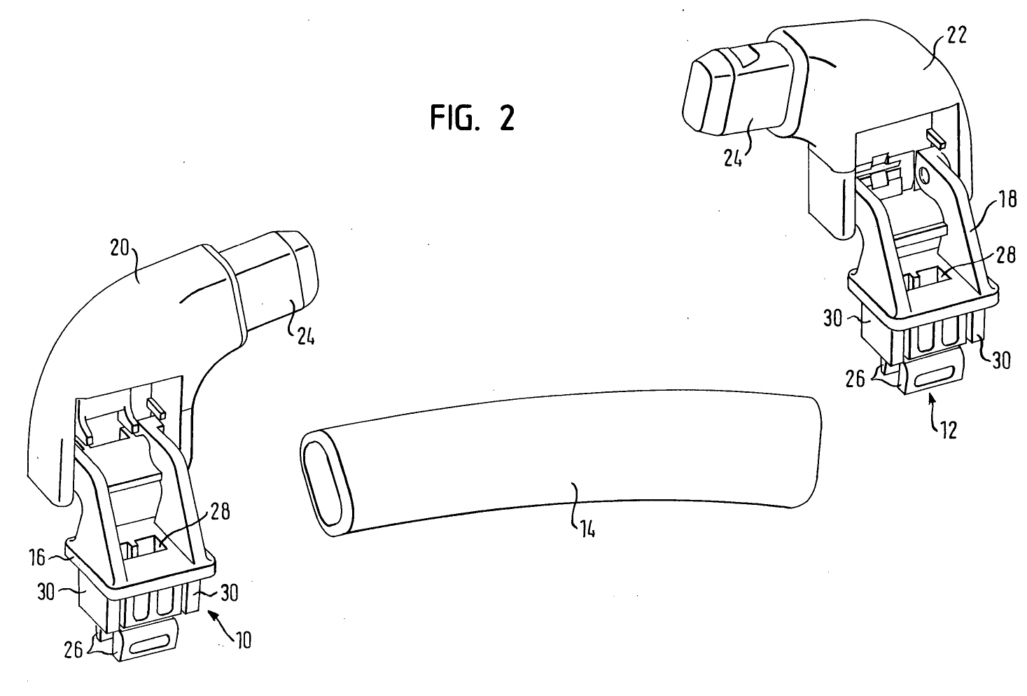

In FIGS. 1 and 2, a grab handle 10 can be seen which is made up of a first support 10, a second support 12, and a grip part 14. Each support 10, 12 is made up of a mounting part 16, 18, respectively, which is provided to be subsequently attached to the vehicle, as well as a support part 20, 22, respectively, which is rotatably attached to the mounting part. Both support parts 20, 22 are joined to grip part 14 so that the latter extends between both supports 10, 12. Mounting parts 16, 18 as well as support parts 20, 22 are made of plastic.

Grip part 14 can be placed on holding extensions 24, which are configured on support parts 20, 22 and are glued, welded, clipped, screwed, or pinned there. Alternatively, it is possible to design the grip part as an integral part of both support parts 20, 22.

Each mounting part 16, 18 is provided with two latching tongues 26, which can be inserted through a mounting opening in the vehicle and are latched on their reverse side. To increase the retention force, a wedge (not shown) is inserted through an opening 28 in mounting parts 16, 18 so that it lies between the latching tongues 26 and presses them apart. In addition to latching tongues 26, stop tongues 30 are provided which act to improve the positioning of the supports in the mounting openings in the vehicle.

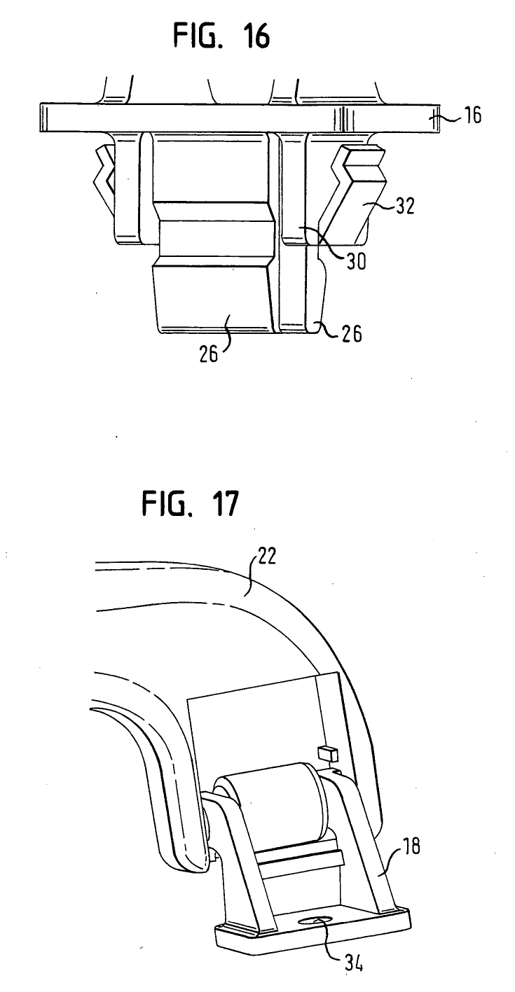

In FIGS. 16 and 17, alternative possibilities for attaching the supports to the vehicle are depicted. In the embodiment depicted in FIG. 16, supplemental retaining clips 32 are provided on stop tongues 30, the retaining clips acting to pre-latch the supports during mounting on the vehicle before the supports are finally attached.

In the embodiment depicted in FIG. 17, an opening 34 is provided in the mounting part, through which a mounting screw can be inserted, thus bolting the support to the vehicle.

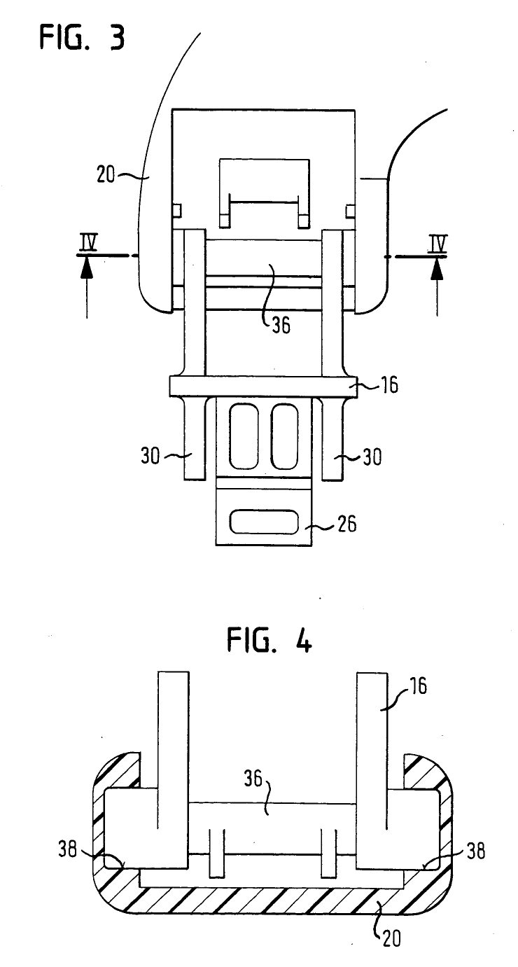

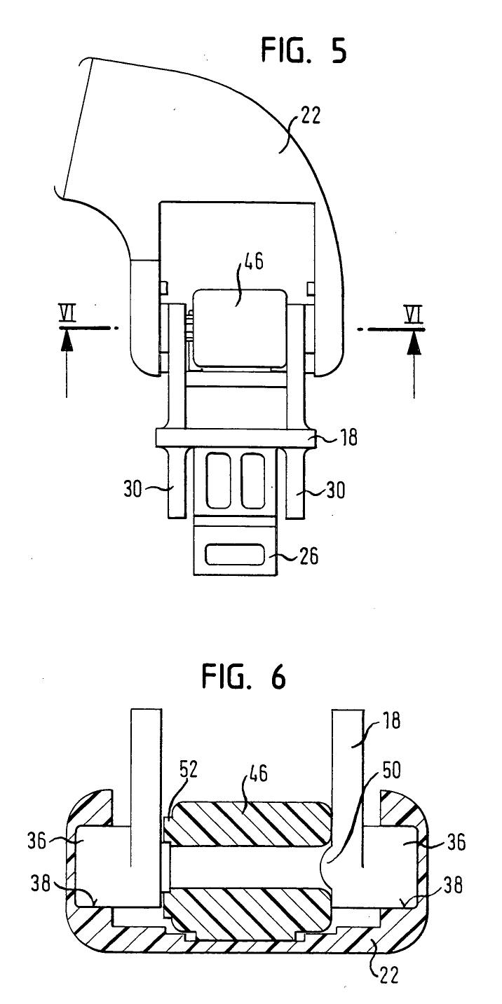

The essential aspect of the supports according to the invention lies in the fact that the mounting parts and the support parts are manufactured so as to be fixedly joined to each other, in that a support spindle 36, which joins the mounting parts to the support parts, is configured as an integral part of the corresponding support part and is injected during the manufacturing process into support openings 38 of the support part. As can be seen in FIGS. 3 and 4, for support 10, support spindle 36 is configured as an integral part of support part 16; the ends extending in the axial direction beyond support part 16 project directly into support openings 38, which are formed in support part 20. Support openings 38 are closed in the circumferential direction and therefore, when viewed in the axial direction, represent depressions having a circular cross-section. In this manner, support spindle 36 is accommodated in support openings 38 without play and without the danger that support part 20 can detach from mounting part 16. As can be seen in FIGS. 5 and 6, support spindle 36 for support 12 is interrupted in the middle, so that support spindle 36 is combined out of two coaxial support pegs. The two support pegs are also directly injected into support openings 38 of support part 22.

On support 10, a return spring 40 is provided (in particular, see FIGS. 7 through 10), which is secured to support part 20 and is supported at its free leg on mounting part 18. Return spring 40 acts to urge grip part 14 into a (folded-back) initial position. To secure return spring 40 to support part 20, a latching guideway 42 is provided, into which one end of spring 40, which is provided with a barb 44, is inserted so that it latches there or sinks into the plastic.

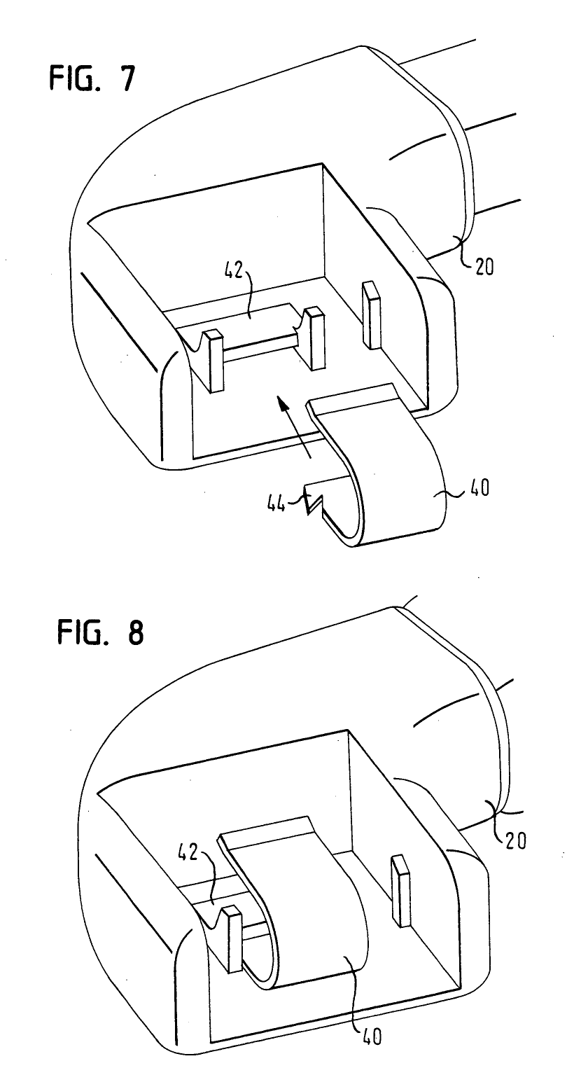

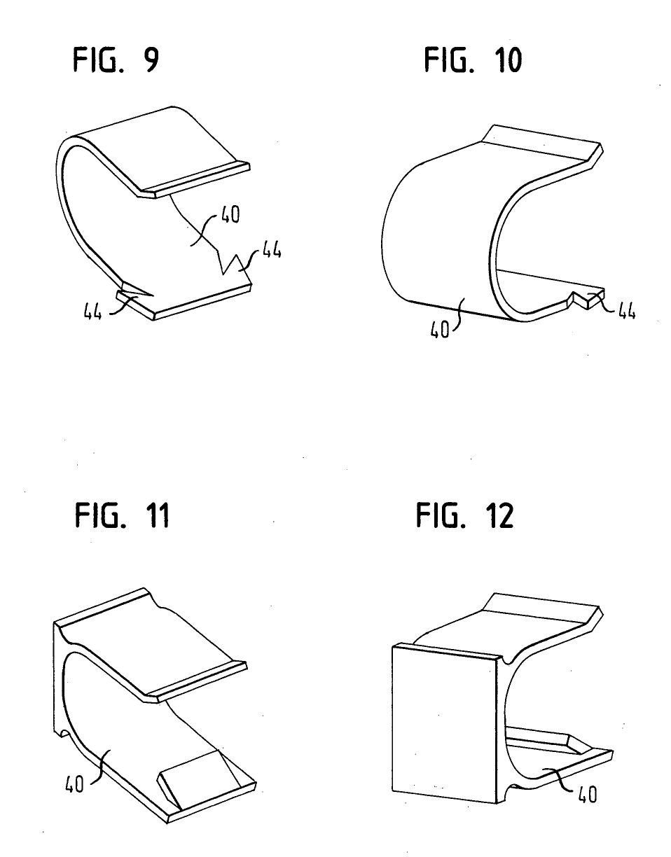

The return spring depicted in FIGS. 9 and 10 is made of spring steel. Alternatively, it is also possible to use a return spring made of a suitable plastic. A return spring of this type is depicted in FIGS. 11 and 12. As a further alternative, a spiral spring made from metal could be used as return spring.

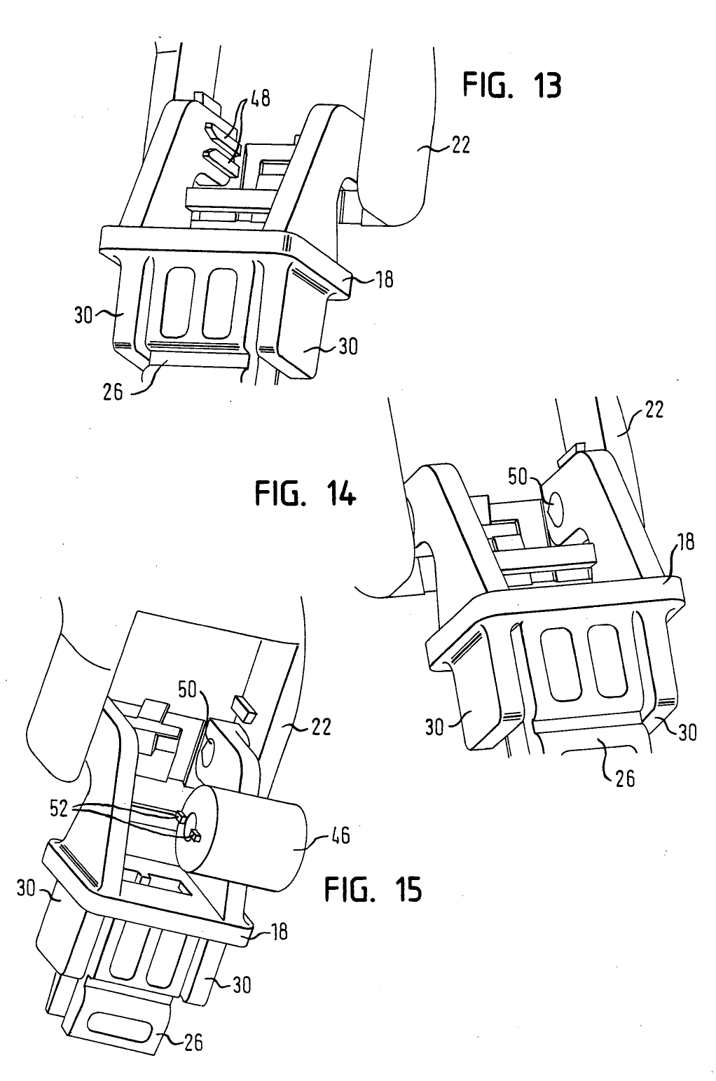

On support 12, a damper 46 is provided (see FIGS. 5 and 6 as well as 15), which acts to dampen the return motion of grip part 14 caused by return spring 40 urging it into the initial position. Damper 46 here is a silicon damper, which generates resistance by displacing a fluid and which is designed as a self-enclosed component that is inserted into a seat on mounting part 18. This seat is made up of two guide bars 48 (see FIG. 13) and a detent projection 50 (see FIG. 14). In this seat, damper 46 latches using two catches 52 on one of its end faces and a recess on the other end face (see FIG. 6).

1. A support for a vehicle grab handle, comprising a mounting part provided to be fastened to a vehicle, a support part provided to be joined to a grip part, and a support spindle by which said support part is rotatably supported on said mounting part, said support spindle being formed as an integral part of said mounting part and being injection-molded into said support part so as to be rotatable with respect to said support part.

2. The support of claim 1 wherein said support part has a support opening for said support spindle and wherein said support opening is closed in a circumferential direction.

3. The support of claim 1 wherein said mounting part is provided with at least one mounting opening for a mounting screw.

4. The support of claim 1 wherein said mounting part is provided with at least one mounting clip.

5. The support of claim 1 wherein a return spring is provided which urges said support part into an initial position relative to said mounting part.

6. The support of claim 5 wherein said return spring is made of plastic.

7. The support of claim 1 wherein said return spring is a spiral spring made from metal.

8. The support of claim 1 wherein a damper is provided which generates a damping in opposition to a reverse motion of said support part relative to said mounting part.

9. A grab handle comprising a grip part and two supports, said grip part being joined to said support parts, each of said support parts comprising a mounting part provided to be fastened to a vehicle, a support part provided to be joined to a grip part, and a support spindle by which said support part is rotatably supported on said mounting part, said support spindle being formed as an integral part of said mounting part and being injection-molded into said support part so as to be rotatable with respect to said support part.

10. The grab handle of claim 9 wherein said grip part is configured integrally with said support parts.

11. The grab handle of claim 9 wherein said grip part is designed as a separate component.

12. The grab handle of claim 11 wherein said grip part is glued to said support parts.

13. The grab handle of claim 11 wherein said grip part is clipped to said support parts.

14. The grab handle of claim 11 wherein said grip part is screwed to said support parts.

15. The grab handle of claim 11 wherein said grip part is pinned to said support parts.
